(19) United States
(12) Patent Application Publication
(10) Pub. No.: US 2023/0354846 A1
(43) Pub. Date: Nov. 9, 2023

(54) Ice Cream Maker

(71) Applicant: ICM Technologies, LLC, Salt Lake City, UT (US)

(72) Inventors: Joseph Shapiro, Bluffdale, UT (US); Kelly Browne, Bluffdale, UT (US)

(21) Appl. No.: 18/143,047

(22) Filed: May 3, 2023

Related U.S. Application Data
(60) Provisional application No. 63/337,717, filed on May 3, 2022.

(51) Int. Cl. A23G 9/22; A23G 9/08

(52) U.S. Cl. CPC A23G 9/224; A23G 9/08

(57) ABSTRACT

An ice cream maker may comprise a sealed inner shell containing ice cream mixture; a sealed outer shell containing salt, ice, and the inner shell; and an insulated bag containing the sealed outer shell. Ice cream may be made by tumbling the insulated bag (containing the outer shell and inner shell) in a dryer.

### CROSS-REFERENCE TO RELATED APPLICATIONS

This Application claims priority to U.S. Provisional Application No. 63/337,717, titled “Ice Cream Maker,” filed on May 3, 2022, the first inventor of which is Joseph Shapiro, and which is incorporated herein by reference in its entirety.

### BACKGROUND OF THE INVENTION

People love ice cream. Ice cream is usually obtained from a store or other outlet where it is pre-made, but it is actually quite easy to make without special machines or ingredients. In general, making ice cream requires only a mixture of cream, milk, and sugar (many variations are possible and well-known), keeping the mixture cold, and mixing or shaking it. Although children, and people in general, often engage in active play, such as jumping on a trampoline or otherwise, heretofore there has not been a good way to harness the active play or activity to mix or shake the ice cream mixture. What is needed is a good way, system, or method for harnessing active play or activity, such as jumping on a trampoline, to make ice cream.

### BRIEF SUMMARY OF THE INVENTION

A method and system are disclosed for making ice cream. In one embodiment, an outer shell is filled with ice and salt. One or more inner shells or containers are filled, or partially filled, with an ice cream mixture (usually based on cream, milk, and sugar), and then sealed. The outer shell and inner shell(s) may be soft, which may promote safety in activity, especially when bouncing the outer shell on a trampoline. The outer shell is sealed. After sufficient shaking, e.g., through bouncing on a trampoline, the inner shell(s) are removed from the outer shell, and the ice cream may be removed from the inner shell(s) and consumed.

In one embodiment the shaking and/or turbulence may be provided by using laundry dryer that turns and/or otherwise tumbles the sealed outer shell and its contents. The laundry dryer may be run on an air-dry setting, a heat-dry setting, or otherwise. In another embodiment a machine or equipment other than a laundry dryer may be used.

In ananother embodiment, the sealed outer shell may be enclosed in a packet/shell to provide padding, insulation, and/or protection against potential leaks.

### BRIEF DESCRIPTION OF THE DRAWINGS

FIG. 1 shows an elevated view of an exemplary embodiment of a hard-shell ice cream maker.

FIG. 2 shows a top-down view of an exemplary embodiment of a hard-shell ice cream maker.

FIG. 3 shows a cross section view of an exemplary embodiment of a hard-shell ice cream maker.

FIG. 4 shows a close-up cross section view of the cap of an exemplary embodiment of a hard-shell ice cream maker.

FIG. 5 shows an elevated view of an exemplary embodiment of a soft-shell ice cream maker.

FIG. 6 shows a top-down view of an exemplary embodiment of a soft-shell ice cream maker.

FIG. 7 shows a cross section view of an exemplary embodiment of a soft-shell ice cream maker.

FIG. 8 shows a close-up cross section view of the cap of an exemplary embodiment of a soft-shell ice cream maker.

FIG. 9 shows an elevated view of a gasket-expanding cap in an open configuration.

FIG. 10 shows a top-down view of a gasket-expanding cap in an open configuration.

FIG. 11 shows a cross section view of a gasket-expanding cap in an open configuration.

FIG. 12 shows an elevated view of a gasket-expanding cap in a closed configuration.

FIG. 13 shows a cross section view of a gasket-expanding cap in a closed configuration.

FIG. 14 shows an exemplary ice cream maker comprising a bag, outer shell, and inner shell.

FIG. 15 shows a top-down view of an exemplary insulated bag.

FIG. 16 shows a top-down view of an exemplary insulated bag.

FIG. 17 shows a top-down view of an exemplary insulated bag.

FIG. 18 shows an upper-elevated-end view of an exemplary insulated bag.

FIG. 19 shows an upper-elevated-angle view of an exemplary insulated bag in an open configuration.

FIG. 20 shows an upper-elevated view of an exemplary outer shell in a closed/sealed configuration.

FIG. 21 shows an upper-elevated view of an exemplary outer shell in a closed/sealed configuration.

FIG. 22 shows an upper-elevated view of an exemplary outer shell in a closed/sealed configuration.

FIG. 23 shows a top-down view of an exemplary outer shell in a partially closed/sealed configuration.

FIG. 24 shows a top-down view of an exemplary outer shell in an open configuration.

FIG. 25 shows a close-up of the female sealing track in an exemplary outer shell.

FIG. 26 shows a close-up of the male sealing track in an exemplary outer shell.

FIG. 27 shows a top-down view of an exemplary outer shell in an open configuration.

FIG. 28 shows an upper-elevated view of an exemplary inner shell in a closed/sealed configuration.

FIG. 29 shows a top-down view of an exemplary inner shell in a partially closed/sealed configuration.

FIG. 30 shows a top-down view of an exemplary inner shell in an open configuration.

FIG. 31 shows an upper-elevated-angle view of an exemplary inner shell in an open configuration.

FIG. 32 shows a close-up of the female sealing track in an exemplary inner shell.

FIG. 33 shows a close-up of the male sealing track in an exemplary inner shell.

FIG. 34 shows a top-down view of an exemplary inner shell in a closed state.

FIG. 35 shows an exemplary inner shell in a closed/sealed state (e.g., containing ice cream mixture) inside an exemplary outer shell in an open configuration.

FIG. 36 shows exemplary outer shell in a closed/sealed state (e.g., containing ice, salt, and a sealed inner shell containing ice cream mixture).

FIG. 37 shows an insulated bag containing a sealed outer shell (e.g., containing ice, salt, and a sealed inner shell containing ice cream mixture).

FIG. 38 shows an insulated bag containing a sealed outer shell (e.g., containing ice, salt, and a sealed inner shell containing ice cream mixture).

FIG. 39 shows an insulated bag containing a sealed outer shell (e.g., containing ice, salt, and a sealed inner shell containing ice cream mixture).

FIG. 40 shows a flowchart for an exemplary method of making ice cream.

FIG. 41 shows an exemplary dryer.

FIGS. 42A-E a time progression for using an ice cream maker as disclosed herein to make ice cream in a dryer.

### DETAILED DESCRIPTION OF THE INVENTION

Several ice cream makers and associated methods are disclosed.

### Table of Reference Numbers From Drawings

The following table is for convenience only and should not be construed to supersede any potentially inconsistent disclosure herein.

| Reference Number | Description |
|---|---|
| 100 | ice cream maker |
| 110 | outer shell |
| 130a-n | ice and salt |
| 140 | closeable opening |
| 145 | cap |
| 150 | inner shell |
| 160 | ice cream mixture |
| 300 | cap |
| 310 | gasket |
| 320 | cap element |
| 330 | lever |
| 340 | bottom plate |
| 500 | ice cream maker |
| 510 | bag |
| 511 | closeable opening |
| 520 | outer shell |
| 521 | closeable opening |
| 522 | first side of sealing track |
| 523 | second side of sealing track |
| 524 | sealing slider |
| 530 | inner shell |
| 531 | closeable opening |
| 532 | first side of sealing track |
| 533 | second side of sealing track |
| 534 | sealing slider |
| 600 | dryer |
| 605 | dryer drum |
| 610a-c | fins |
| 620 | direction of rotation of dryer drum |
| 4000 | flowchart of exemplary method |
| 4010 | step from flowchart |
| 4020 | step from flowchart |
| 4030 | step from flowchart |
| 4040 | step from flowchart |
| 4050 | step from flowchart |
| 4060 | step from flowchart |
| 4070 | step from flowchart |
| 4080 | step from flowchart |

### First Embodiment

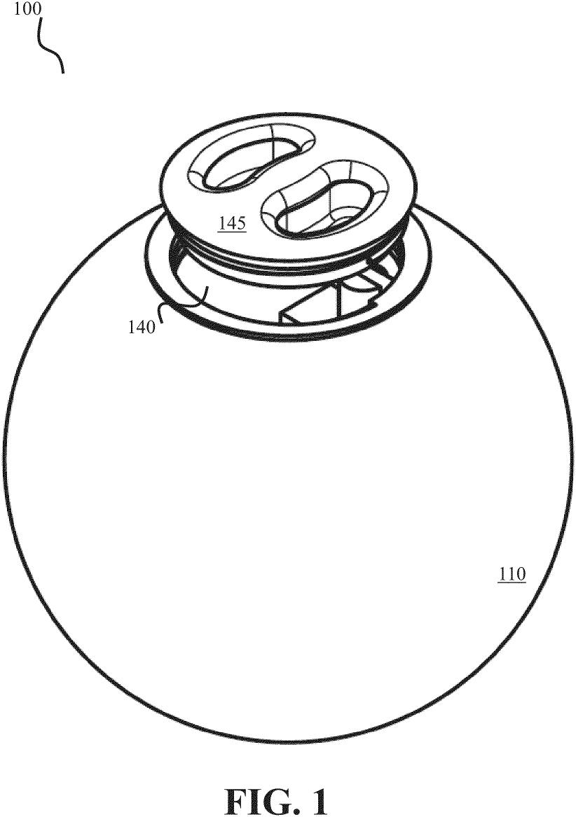

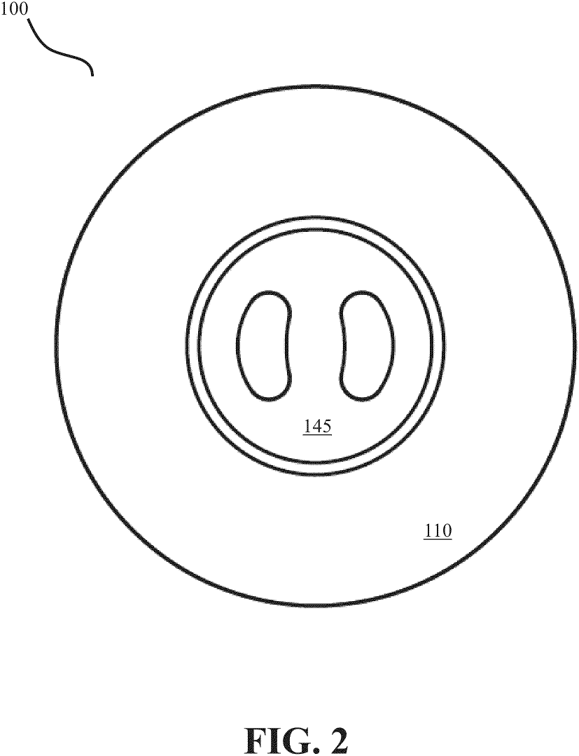

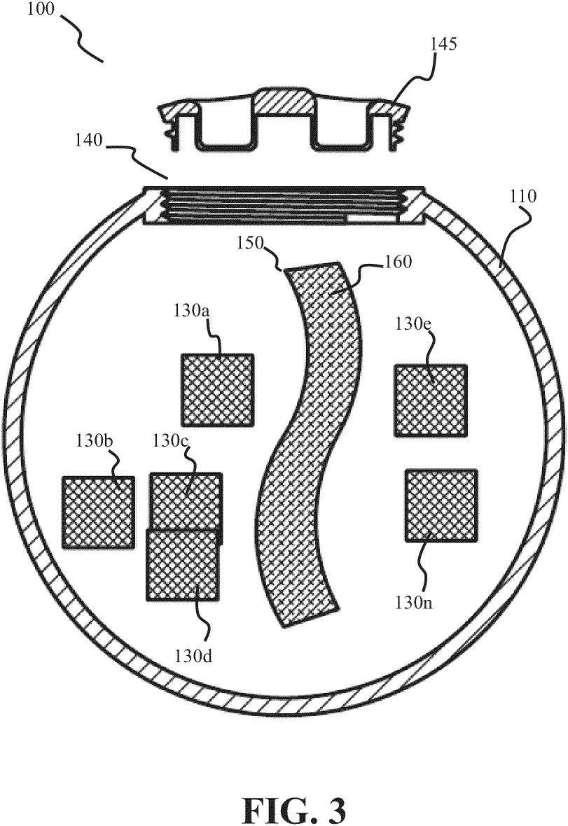

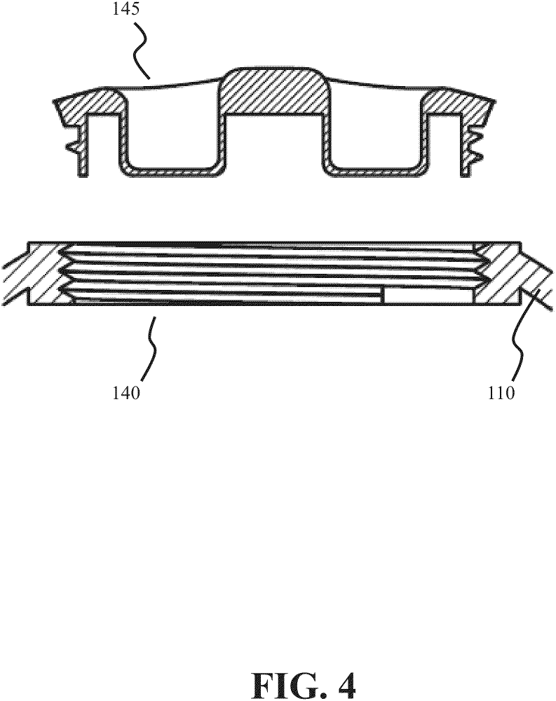

A system, apparatus, and method for making ice cream using a bouncing apparatus is disclosed. In one embodiment, as shown in FIGS. 1-4, an ice cream maker 100 comprises an outer shell 110 for holding ice and salt 130a-n, and an inner shell 150 for holding ice cream mixture 160 that eventually becomes ice cream. In one embodiment, inner shell 150 is at least partially filled with an ice cream mixture 160, sealed, and placed inside outer shell 110. Outer shell 110 is at least partially filled with ice and salt 130a-n, and then sealed with the ice and salt 130a-n and inner shell 150 contained inside. Outer shell 110 may then be bounced or shaken to make ice cream. In one preferred embodiment, depending on factors including but not limited to size and shape of inner shell 150 and outer shell 110, the amount of ice and salt 130an, the amount of ice cream mixture 160, and outside temperature, it may take 10-30 minutes of shaking or bouncing to make ice cream, i.e., before the ice cream mixture becomes ice cream. In a one embodiment, shaking, bouncing, and/or mixing is accomplished by bouncing the outer shell on a trampoline. The shaking, bouncing, and/or mixing could also be accomplished in other ways, including but not limited to throwing, kicking, playing in a swimming pool or other water, or any other means for bouncing, shaking, mixing or some combination thereof.

In one embodiment, outer shell 110 may be a sphere approximately 12.0 inches in diameter. Outer shell 110 may be other shapes or sizes. For example, outer shell 110 may be a cube, or may be flexible such that the shape changes. Various shapes have various advantages. For example, a cube is uniform and may therefore bounce randomly, which may be advantageous in some situations, circumstances, or games, e.g., trying to dodge the bouncing cube. Different sizes may be appropriate depending on: the volume of ice cream to be made, the size and age of people bouncing and shaking the ice cream, the amount of empty volume in outer shell 110, or other reasons which will be appreciated by a person or ordinary skill.

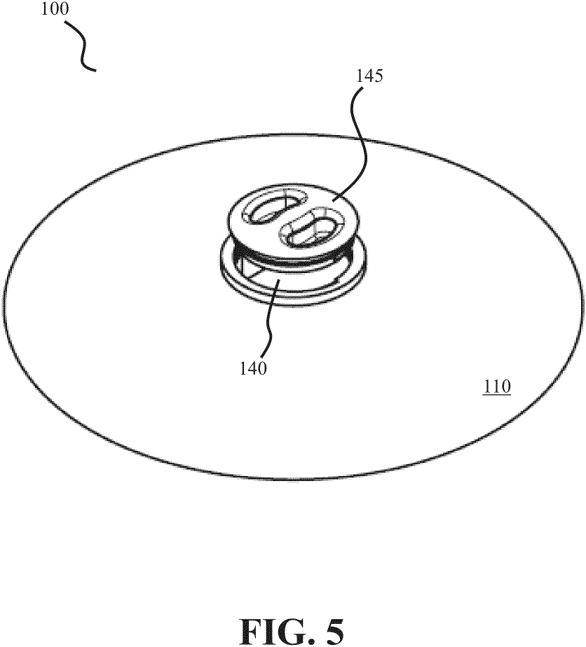

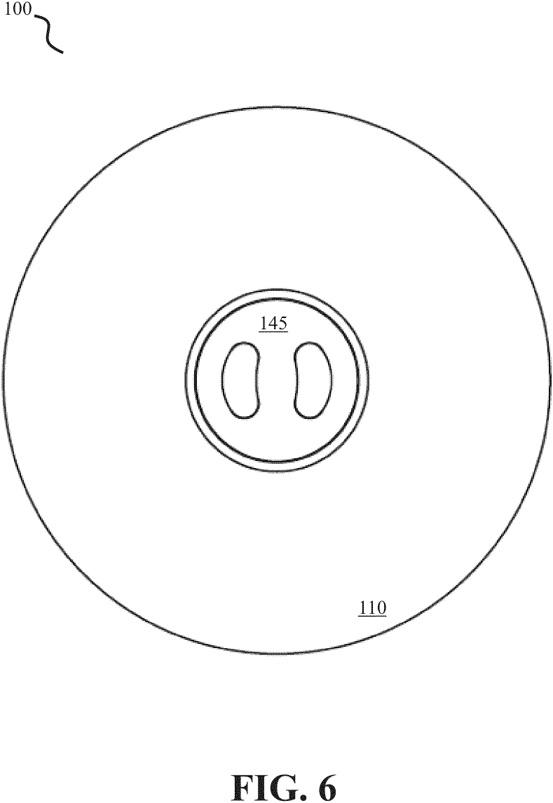

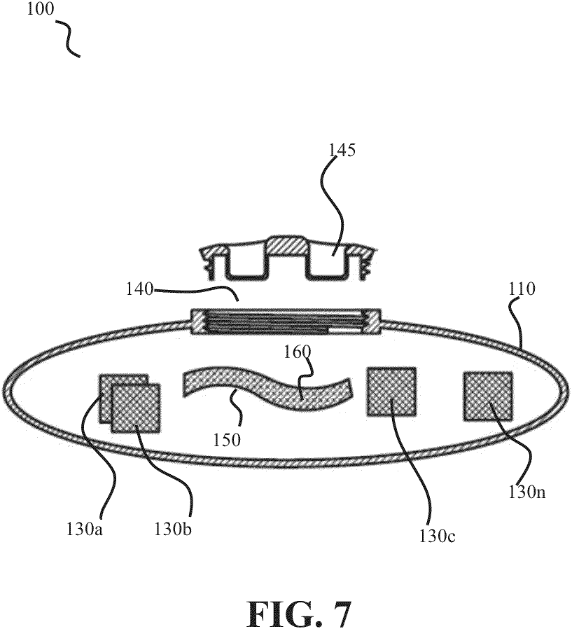

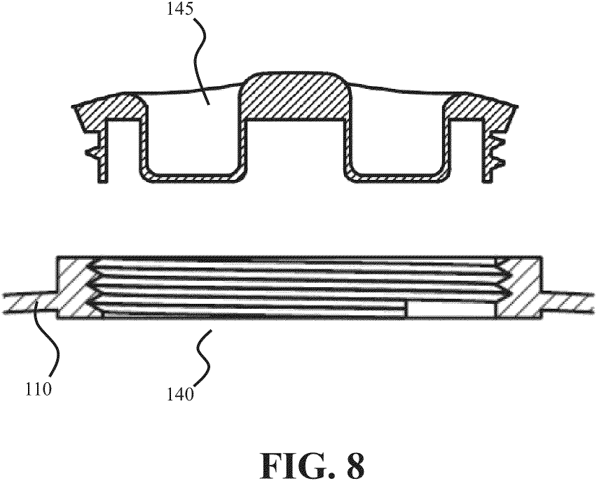

In another embodiment, outer shell 110 may be a flexible or soft shape, such as a beach ball or disk shape. In one embodiment, such outer shell may be approximately 12 inches in diameter. An exemplary soft outer shell embodiment is shown in FIGS. 5-9.

Outer shell 110 may be rigid, flexible, partially rigid, and/or flexible. For example, outer shell 110 may be fully flexible, such as the material used to make a beach ball, or may be fully rigid, such as a hard plastic material such as the material used for plastic jugs of protein powder or similar products and applications. The material for outer shell 110 may also be partially flexible and/or rigid, or may have some portions with a different rigidity than other portions. Flexible materials may be safer in bouncing situations, but also may not bounce as well or may be more difficult to throw, catch, and otherwise manipulate. Rigid materials for outer shell 110 may bounce better but may be more dangerous because of the hardness. A rigid outer shell 110 may also be easier to throw, catch, or otherwise manipulate.

Outer shell 110 may be made out of many materials well known in the art, including but not limited to plastic, rubber, plastisol, polyethylene, TPU (thermoplastic polyurethane) and many variations and brands of such products. In one embodiment, outer shell 110 may be made of 0.3 mm TPU. It should be appreciated that different thicknesses of material may be used. In general, as thickness decreases, outer shell 110 may become less strong, less durable, less resistant to tear and puncture, more flexible, and more translucent. As thickness increases, outer shell 110 may become stronger, more durable, more resistant to tear and puncture, less flexible, and less translucent.

In one embodiment, outer shell 110 may be made of phthalate free plastisol that is approximately 0.25 inches thick. The material for outer shell 110 does not have to be food safe because it will not come in contact with the ice cream 160, but will come in contact only with ice and salt 130a-n, which will be discarded and not consumed.

In one embodiment, outer shell 110 may be made out of materials such as the rubber bladder of a soccer ball, such as the rubber bladder of a size 4 soccer ball.

In one embodiment, outer shell 110 may be made from a flexible foam of polyurethane material of approximately 2 lb density. The flexible foam may be lined on the interior with a thick flexible inner TPU shell, approximately 2 mm thick, for a water-tight seal. The combination of the inner lining and foam material may have a combined thickness of approximately 1.0 inches. Other materials of differing flexibility and thicknesses may be used for the interior lining and the exterior foam. The exterior foam and the interior lining may form a water-tight seal with closeable opening 140 which may use a cap 145, screw-on cap 145, clamp, zipper, ties, squeezing mechanism or any other liquid-tight means. A person of ordinary skill will appreciate that the density and thickness of the outer material and the thickness of the inner material may be modified or adjusted.

Outer shell 110 may be transparent, translucent, solid-colored, or colored with patterns, shapes, or words. A transparent or partially transparent outer shell 110 may be desirable in some circumstances because it may be fun and interesting to see what is happening with the ice and salt 130a-n, and inner shell(s) 150 with ice cream mixture 160, and it may also be convenient for monitoring the progress of making the ice cream. Many colors, patterns, images, words, logos, trademarks, and levels of opacity may be applied to outer shell 110.

In a one embodiment, outer shell 110 has a closeable opening 140 for inserting and removing ice and salt 130a-n, and also for inserting and removing inner shell(s) 150 containing ice cream mixture 160. The size and shape of closeable opening 140 may vary. In general, closeable opening 140 will be more convenient if it is large enough to easily insert and remove ice and salt 130a-n and the inner shell(s) 150, but small enough that most of outer shell 110 can be filled without the contents falling out of closeable opening 140. In one embodiment, closeable opening 140 in outer shell 110 may be a circle approximately 3.0 or 3.5 inches in diameter. The opening size of closeable opening 140 may vary depending on the size of outer shell 110 and other factors.

Closeable opening 140 may close and open in a variety of ways well known in the art. In one embodiment, closeable opening 140 may have a circular plastic cap 145 that screws into or onto threads onto outer shell 110. Closeable opening 140 may also use zippers, clamps, nuts and bolts, an expanding gasket, a self-sealing fold-over material, ties, a wire bail lid (as often used for food canning/jarring applications, or any other means known in the art.

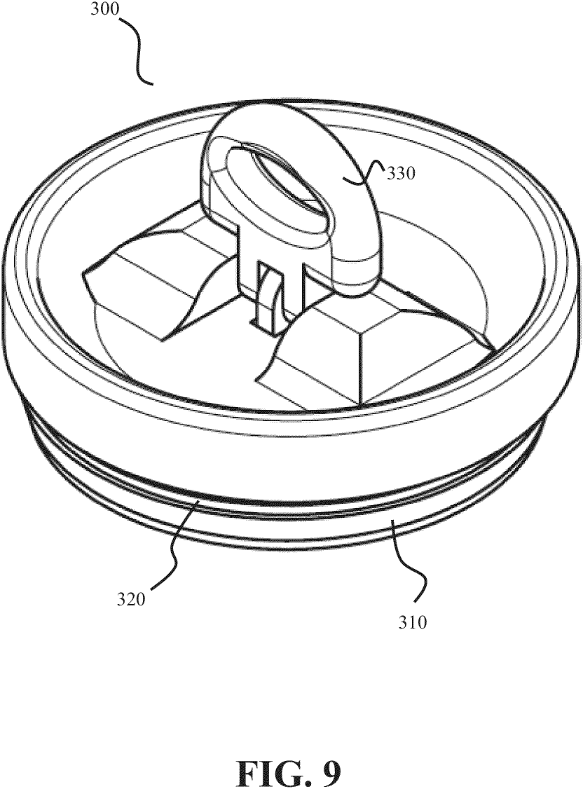

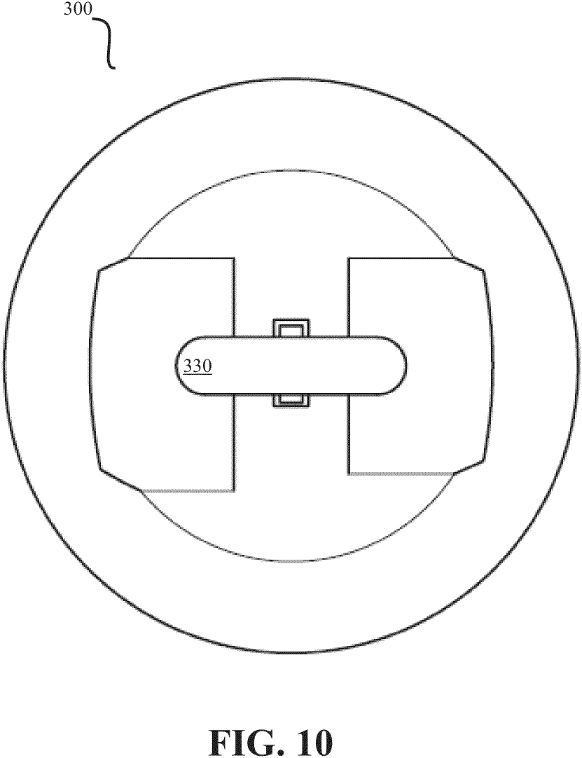

In another embodiment, closeable opening 140 may comprise an expanding gasket mechanism, or cap, 300, as shown in FIGS. 9-13. Expanding gasket cap 300 may be configured to pull a gasket 310 over a form 320 that tapers outward, thereby creating a seal. For example, closeable opening 140 may include a female circular receiving hole with a short cylinder at the top. A male cap 300 may have a substantially complementary size and shape, but may be flared outward at form 320 where the corresponding cylinder is located on closeable opening 140. Male cap 300 may include a rubber, silicone, plastic (or other material) gasket 310, the shape of which may substantially track the opening in closeable opening 140. Male cap 300 may include a mechanism for pulling gasket 310 upward (and outward over the flared tube element 320), to create a seal.

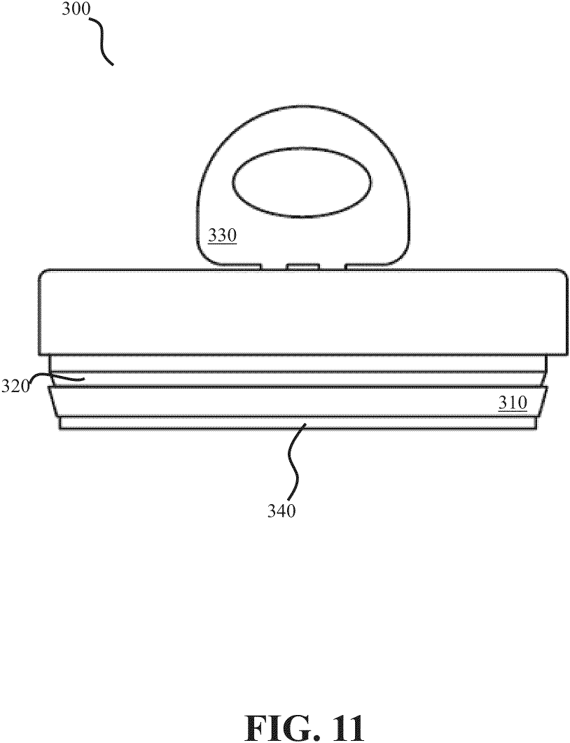

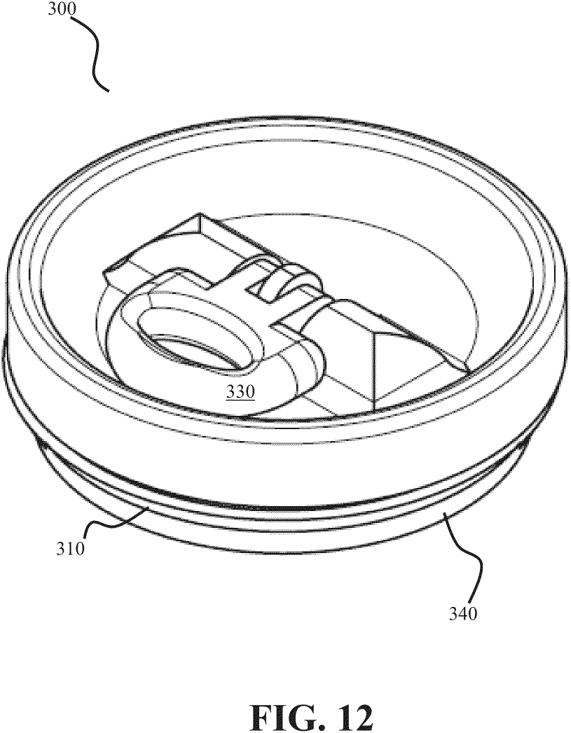

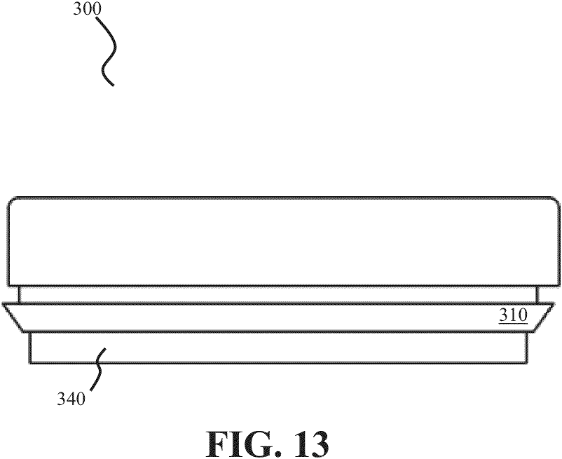

In one embodiment, the mechanism in male cap 300 for pulling gasket 310 up and over flared form 320 may comprise a lever 330 which is mechanically connected to bottom plate 340 so that when lever is manipulated from the open position, as shown in FIG. 11, to the closed position, as shown in FIGS. 12-13, bottom plate 340 is pulled upward, thereby forcing gasket 310 to expand over flared form 320. When gasket 310 expands, it is mechanically pressed into cylindrical opening on closeable opening 140, thereby creating a seal.

In another embodiment, closeable opening 140 may be covered by a piece of TPU or other material secured in place with a rubber band, or elastic strap, or tightened band.

The closing materials or hardware that are part of outer shell 110 (i.e., a removable cap or other part), may be bonded, sealed, mechanically attached, or otherwise attached to the outer shell in many ways well-known in the art. In general, the method or solution for bonding the closeable materials parts to the outer shell, or manufacturing the closeable opening parts as part of outer shell 110, will depend on the materials for outer shell 110 and closeable opening parts. Glue, adhesives, mechanical seals, heal welding, and sonic welding are some exemplary solutions for securing to the outer shell.

In one embodiment, it may be possible to add air to outer shell 110. For example, outer shell 110 may be similar to a beach ball or a sporting ball bladder, having a nozzle or valve for adding or removing air. Adding or removing air may change the characteristics of outer shell 110 for bouncing, shaking, throwing, kicking, or otherwise manipulating the outer shell.

To make ice cream, ice and a solute, e.g., rock salt, may be inserted into outer shell 110 through closeable opening 140. The ice may be made from water, or water with additives, or any other solvent material or composition that may have desirable properties for a particular application. In a preferred embodiment, the ice is made from water. The solute may be one of many different types of salts or other solutes depending on particular applications and desired outcomes. In general, different types of salts may change the freezing properties of an ice/water mixture, as will be well understood by a person of ordinary skill. Common types of salts used include the chemicals NaCl and CaCl₂. The dissolving of these salts causes the dissociation of two or three ions into the liquid water solvent, respectively, which in turn decreases the freezing temperature of the solvent. This permits the liquid solvent to exist in a liquid phase below its solute-free freezing temperature. These lower temperatures allow for the formation of ice cream in the inner shell(s), where ice cream forms at temperatures below zero degrees Celsius. In a preferred embodiment, a salt product of the chemical formula NaCl such as “ice cream salt,” or “Morton® Ice Cream Salt,” or “rock salt,” or similar products may be used. The ratio of ice to salt, and the amount of ice and salt, may affect cooling and freezing times. The percentage of salt mass to ice mass may range from 0 to 25% depending on the desired freezing temperature of the solvent, or other reasons which will be appreciated by a person or ordinary skill. The freezing point of water at these solute levels may range from 0° C. to -21° C., respectively. In a preferred embodiment, the mass ratio of ice to salt may be 10%, corresponding to freezing temperature of approximately -10° C. In general, the amount of ice and salt in outer shell 110 should be sufficient so that the as much as possible of the surface area of inner shell 150 remains in contact with the ice/salt mixture. In general, ice cream mixture 160 will freeze and become ice cream more quickly according the amount of the surface area of inner shell 150 that remains in contact with the ice/salt mixture.

Inner shell 150 may also be referred to as the “ice cream container.” In a preferred embodiment, inner shell 150 is filled, or partially filled, with an ice cream mixture. Many recipes are well known for making ice cream. One exemplary recipe comprises two parts cream, one part whole milk, and salt, sugar, and vanilla to taste. As is well-known in the art, softness or other characteristics of ice cream may vary depending on sugar content or other factors.

Inner shell 150 is preferably made from a food safe material and has a closeable opening for inserting ice cream mixture and removing ice cream. Inner shell 150 may be rigid or flexible, and may have various shapes, colors, opacities, and means for opening and closing.

For example, in one embodiment, inner shall 150 may be made from vinyl tubing. Wall thickness may vary, but should be thick enough to be durable but thin enough to remain flexible. For example, the vinyl tubing may be ¾″ inner diameter, or 1″ inner diameter, and the wall thickness may be approximately ⅛″. Other diameters and wall thicknesses will be appropriate for various circumstances. The vinyl tubing may have different lengths depending on size of outer shell 150, number of inner shells 150 in outer shell 110, desired serving size, size of closeable opening 140 in outer shell, etc.

Vinyl tubing, or tubing in general, may have several advantages. For example, the surface area to volume ratio of tubing is high, which makes it more likely that all the ice cream mixture will be frozen into ice cream. In some instances, ice cream mixture that is not near the inner surface of an inner shell 150 may not get sufficiently cold to fully become ice cream (although this phenomenon may be desirable for some applications). Also, removing ice cream from vinyl tubing is convenient because it may be simply squeezed out, without using any utensils or other tools or implements. Vinyl tubing may be closed with clamps, barbs, plugs, heat sealing, glue, adhesive, or any other way known in the art. As is also known in the art, the vinyl tubing may be folded over for clamping purposes or to otherwise further facilitate closing and sealing.

In general, the material for the inner shell may be plastic, rubber, one or many types of plastic, vinyl, or any other material into which an ice cream mixture may be inserted. Glass may also be used, but glass may be dangerous because of the breaking hazard while being bounced and shaken.

The inner shell may be flexible, rigid, or somewhere between on the continuum of rigidity. In general, a flexible material may be safer if the outer shell is being bounced on a trampoline, thrown, kicked, etc. In general, shapes with high ratios of surface area to volume generally result in faster and more uniform freezing of the ice cream. As with the outer shell, the closeable opening may use a cap, screw-on cap, clamp, zipper, ties, squeezing mechanism or any other liquid-tight means.

In one embodiment, inner shell 150 may be a plastic tube similar to an Otter Pop®, and may be factory sealed, tied like a balloon, sealed like a Ziploc® bag, or closed in any other way known in the art. In one embodiment, the plastic tube may be 2″ polyethylene tubing with a wall thickness of 2-mil. The thickness of the polyethylene may be increased or decreased. In general, the thicker the polyethylene, the more resistant to failure, tearing, and bursting. The size of the polyethylene tubing may vary from 2 inches depending on the needs, requirements, or characteristics of a particular application. Thicker tubing walls may decrease heat transfer between the ice solution in the outer shell and the ice cream mixture in the inner shell. In one embodiment, the tubing may be three-inch (measurement when flat) tubing and may have a wall thickness of 6 mil.

The inner shell(s) may be disposable or reusable.

In one embodiment, it may be desirable to leave a portion of inner shell 150 empty, i.e., free from ice cream mixture 160 and from air or other substance. This gives inner shell 150 the ability to be folded over and compacted during the turbulence of shaking or bouncing, without exploding as the pressure increases because of decreasing interior volume as inner shell 150 is folded over and compacted.

Also, as discussed above, the wall thickness of inner shell 150 is generally thick enough for durability, but thin enough for heat transfer and to improve flexibility where flexibility is required.

More than one inner shell 150 may be placed in the outer shell. In general, the only limit is space in outer shell 110 and whether the ice/salt to ice cream mixture will remain high enough for freezing.

In one embodiment, instead of using reusable inner shells 150, pre-filled and sealed ice cream mixtures may be acquired and simply placed into outer shell 110 with the ice/salt mixture 130a-n for making ice cream. In one embodiment, these pre-filled and sealed ice cream mixtures may be a small plastic flexible tube, e.g., as is well-known for Otter Pops® popsicles. Using such disposable inner shells 150 increases convenience for a user of this invention, and also ensures a good ice cream mixture and recipe.

This invention could be used for foods other than ice cream, although ice cream is one of the most beneficial uses of this invention.

The apparatus described herein may be referred to as an “Ice Cream Maker.”

### Second Embodiment

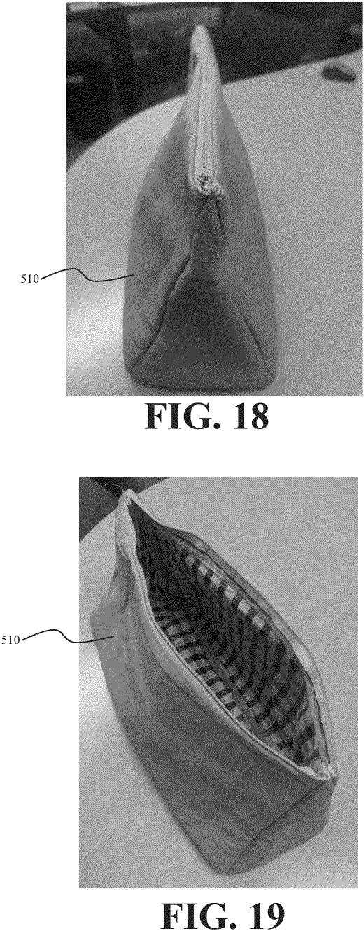

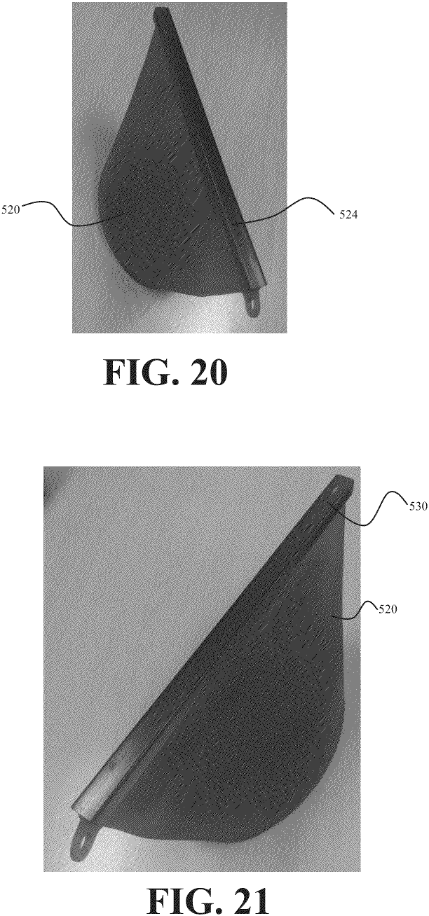

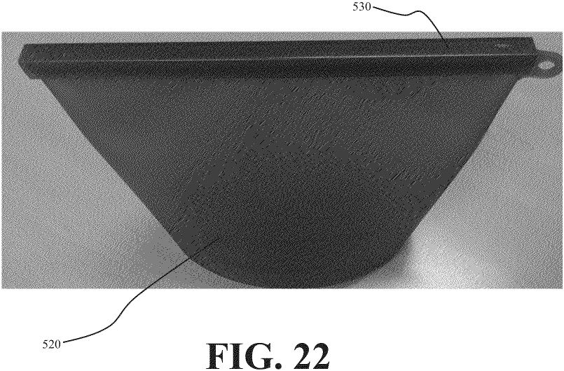

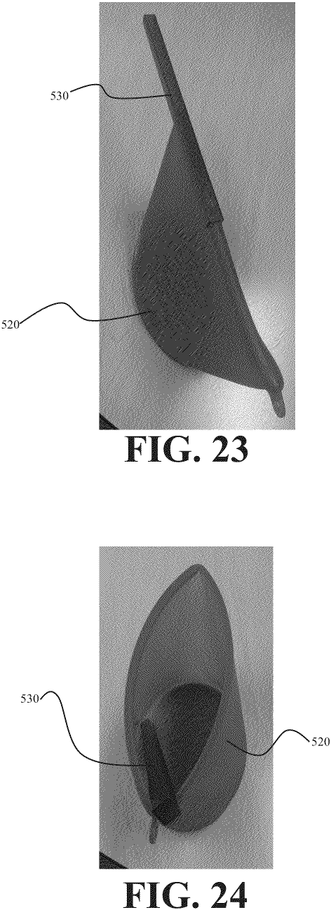

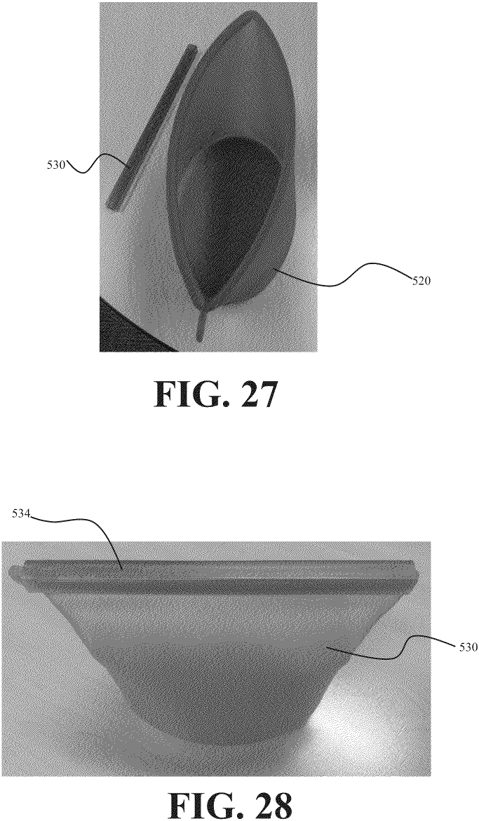

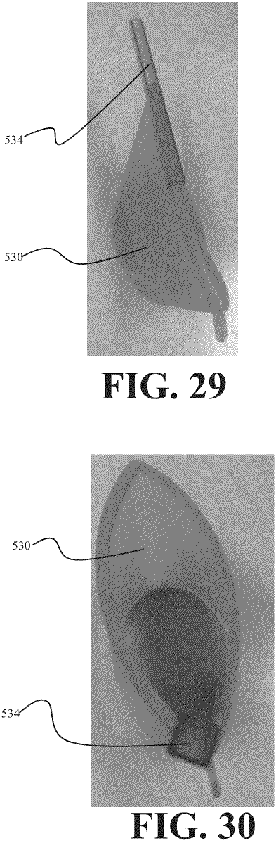

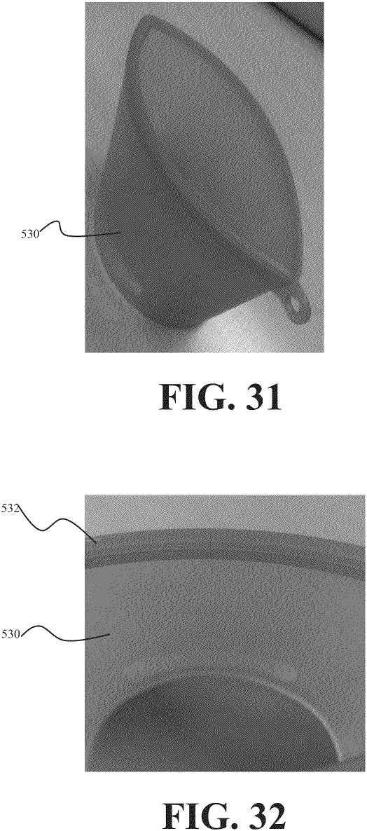

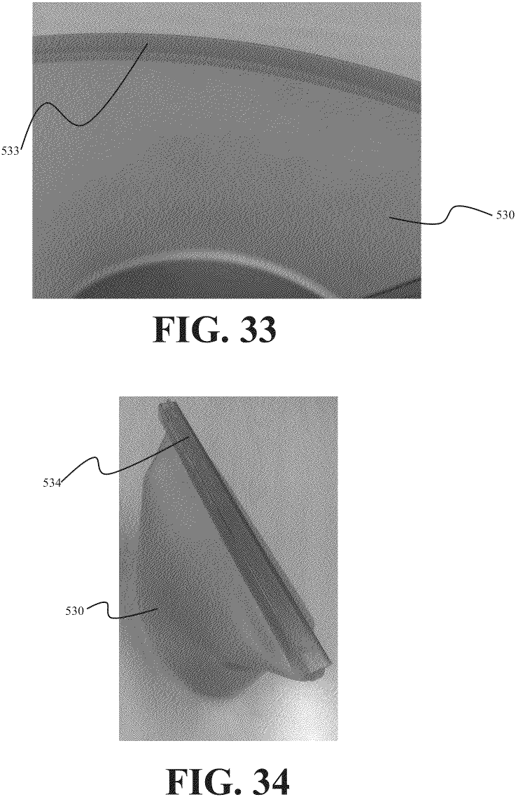

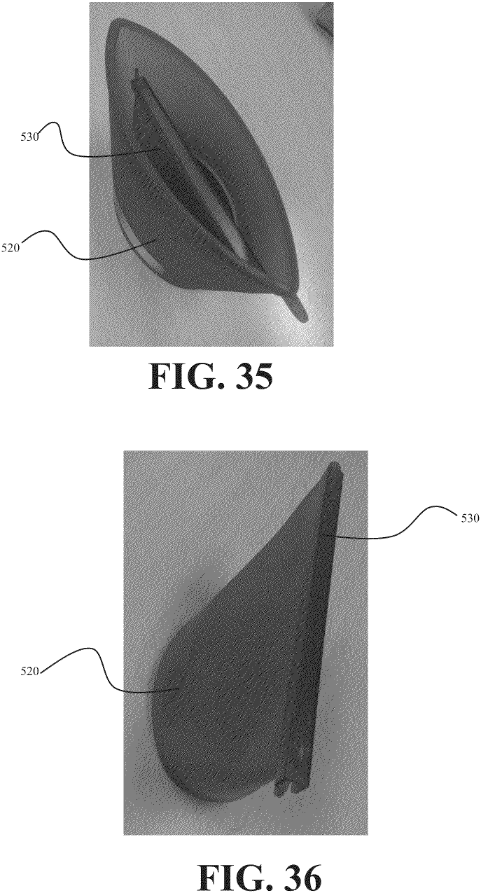

In another embodiment, as shown in FIGS. 20-36 outer shell 520 and/or inner shell 530 may be made from silicone or a similar material, and may seal using a fold, a clasp, a Ziploc®-style seal, or any other way known in the art. In one embodiment, the silicon bag/shell may seal by sliding a seal component (“slider”) over interlocking edges. FIGS. 20-36 show exemplary silicone bags.

In one embodiment, (i) outer shell 520 may have the shape shown in FIGS. 20-36 and may have a volume of 2.5 quarts and (ii) inner shell 530 may have the shape shown in FIGS. 20-36 and may have a volume of 1.2 quarts.

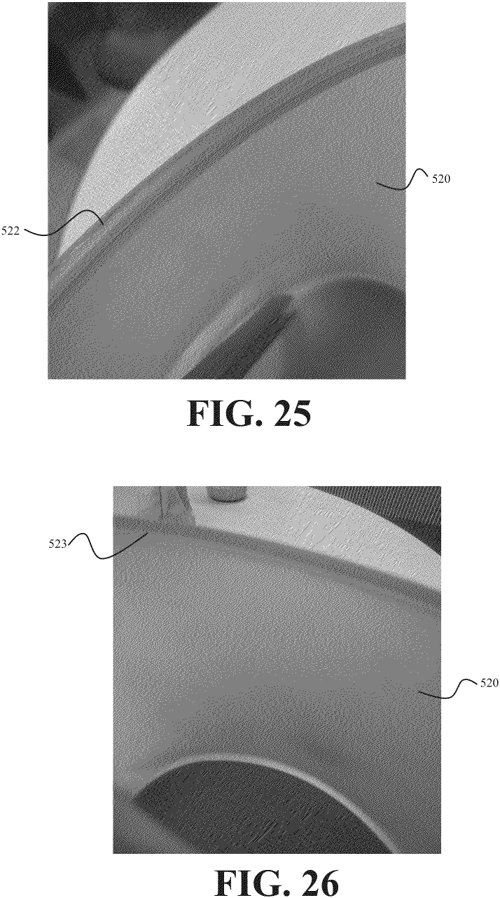

The sealing mechanism for outer shell 520 and inner shell 530 may be a track system with a sealing slider. FIGS. 25 and 26 show a complementary male/female track sealing system with a sealing slider. FIG. 25 shows a first side 522 (female side) of sealing track on outer shell 520. FIG. 26 shows a second side 523 (male side) of sealing track on outer shell 520. After first side 522 has been mated to second side 523, sealing slider 524 slides over the mated track to keep the seal in place. The sealing mechanism for inner shell 530, comprising first side of sealing track 532, second side of sealing track 533, and sealing slider 534 functions similarly. Such sealing system are well-known in the art and are widely available for silicone bags and possibly for other materials.

### Process for Making Ice Cream in a Turbulence/Tumbling Apparatus

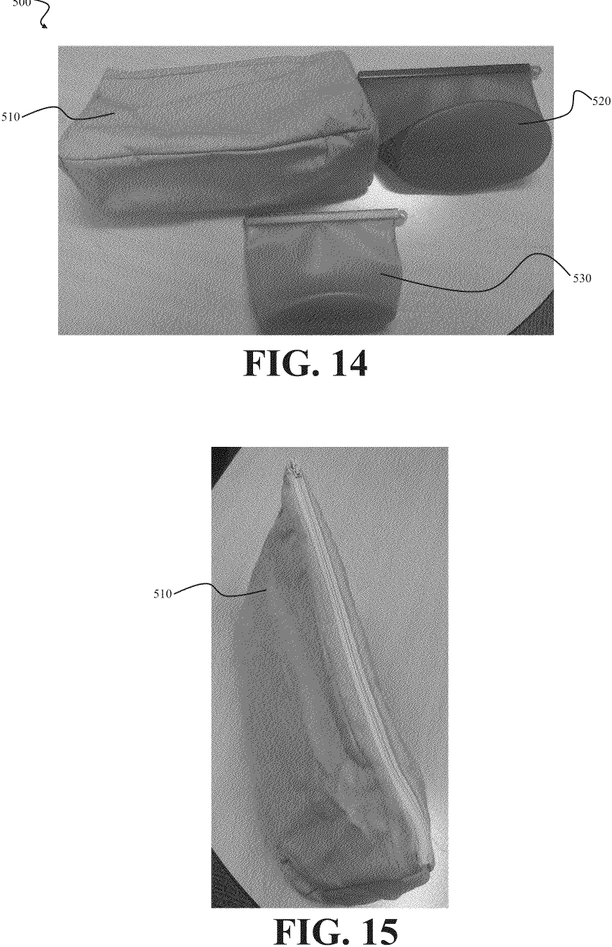

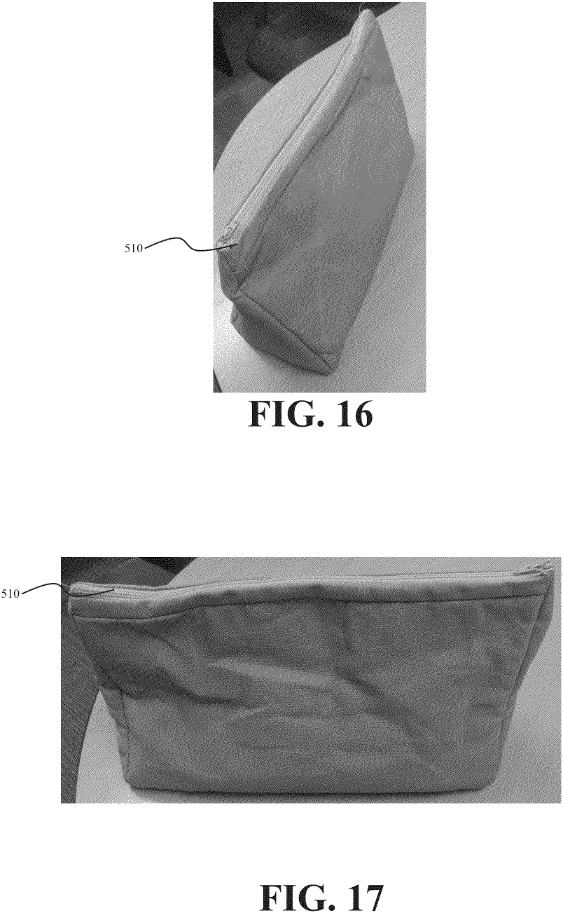

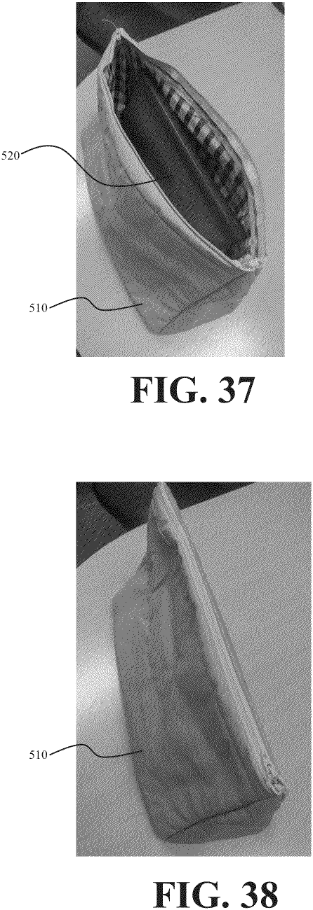

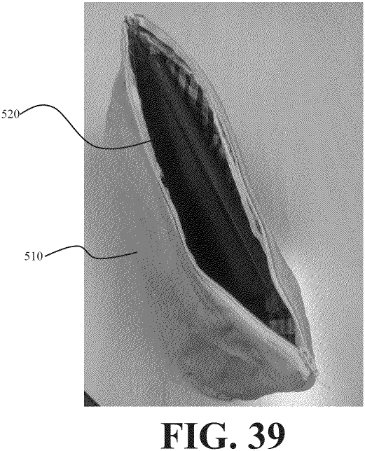

In one embodiment, a process for using the ice cream makers described herein, or any other ice cream maker, may comprise using a machine to subject ice cream maker to turbulence, shaking, bouncing, tumbling, etc. Although discussion herein below focuses on ice cream maker 500 shown in FIGS. 14-39, other ice cream makers may be used similarly.

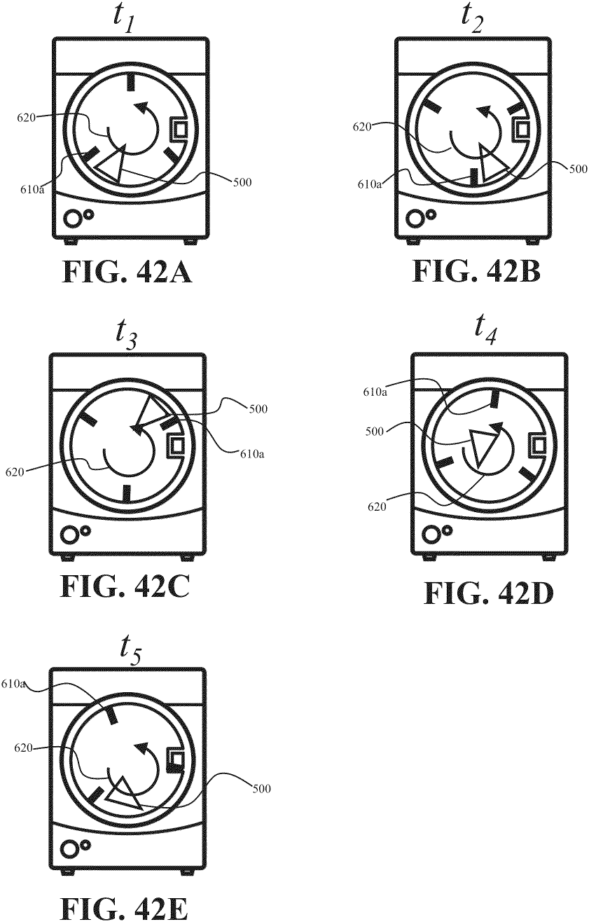

As shown in FIGS. 41-42, this machine may be a dryer 600. Using a dryer may be convenient because dryers are widely available (many people have a dryer in their home) and many dryers are configured to spin/rotate a drum around a horizontal axis. Additionally, conventional dryer designs have fins so that clothes or other things in the dryer are forced/pulled to the top of the dryer before falling to the bottom, which creates good turbulence/shaking for the ice cream makers described herein.

Because making ice cream requires cold temperatures and freezing, it may be desirable to use a dryer on the coldest setting possible. Many dryers have an “air dry” or “no heat” option that may be used for making ice cream. Although using heat in the dryer may be somewhat less effective, it may still work to create ice cream. For example, a low-heat, or medium-heat, or high-heat setting may work as long as there is sufficient ice in the ice cream maker to keep the mixture cold enough for a sufficiently long amount of time. Or the ice and/or rock salt may be periodically replaced if the ice melts too quickly.

FIG. 41 shows an exemplary dryer 600, which includes fins 610a-c. FIGS. 42A-42E show dryer 600 with ice cream maker 500 inside at times t₁, t₂, t₃, t₄, and t₅. As shown in FIGS. 42A-E, dryer 600 is rotating its drum in direction 620. As shown in FIGS. 42A-E, ice cream maker 500 includes bag 510. Bag 510 contains outer shell 520, which is sealed and contains inner shell 530, ice, and salt. Inner shell 530 is sealed and contains ice cream mixture.

As shown in FIG. 42A, at time t₁ ice cream maker 500 is on bottom of dryer drum 605 and is being pushed in direction 620 by fin 610a. As shown in FIG. 42B, at time t₂ ice cream maker 500 is in the position shown and is being pushed in direction 620 by fin 610a. As shown in FIG. 42C, at time t₃ ice cream maker 500 is in the position shown and is being pushed in direction 620 by fin 610a. As shown in FIG. 42D, at time t₄ ice cream maker 500 is free falling within dryer drum 605. As shown in FIG. 42E, at time t₅ ice cream maker 500 has landed on the bottom of dryer drum 605 and is being pushed in direction 620 by fin 610a.

Depending on the rotation speed, ice cream maker 500 may free fall or may be pushed around the entire outside if the rotation speed of dryer drum 605 is sufficiently high. Additionally, as noted herein above, other variants on the ice cream maker may be used. For example, the ice cream maker may not have an exterior bag 510.

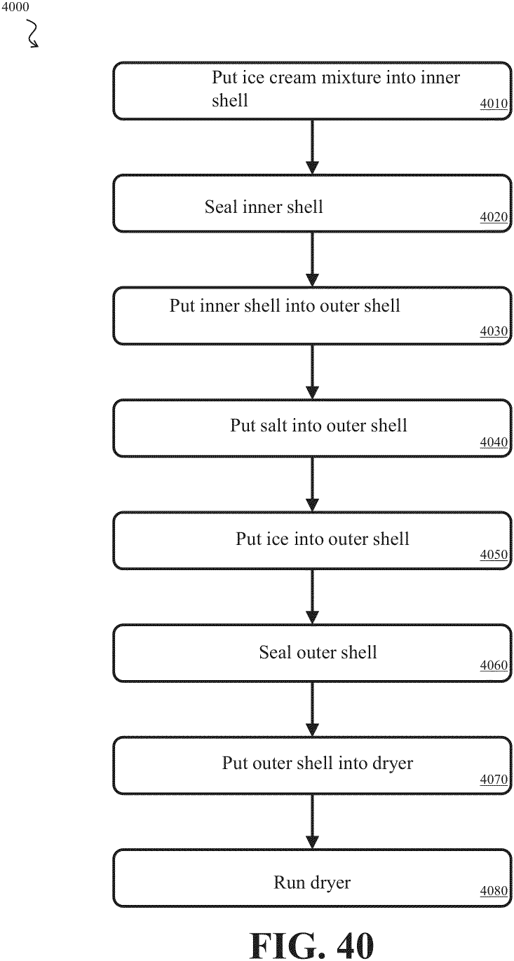

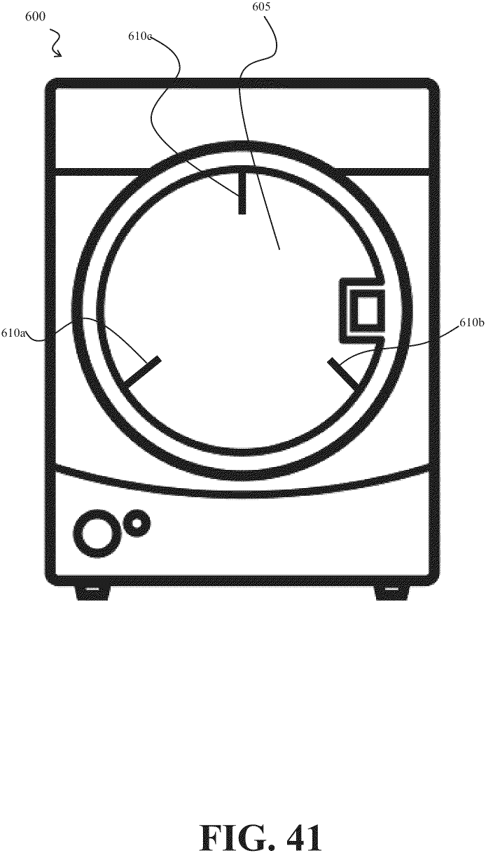

FIG. 40 is a flowchart 4000 for using ice cream maker 500 to make ice cream in dryer 600. At step 4010, ice cream mixture is put into inner shell 530.

At step 4020, inner shell 530 is sealed.

At step 4030, inner shell 530 is put into outer shell 520.

At step 4040, salt is put into outer shell 520.

At step 4050, ice is put into outer shell 520.

At step 4060, outer shell 520 is sealed. Outer shell 520 may optionally be placed into bag 510.

At step 4070 outer shell 520 (and bag 510 if being used) is placed into dryer 600.

At step 4080, dryer 600 is run so that it rotates.

The steps shown in FIG. 40 may be performed in a different order and some may even be performed simultaneously as long as the ice cream mixture is added to the inner shell, the inner shell is sealed, the inner shell is inside the outer shell, the outer shell also contains ice and salt, the outer shell is sealed, and the outer shell is tumbled or otherwise subjected to turbulence in the dryer.

In one embodiment, 10-15 minutes may be sufficient to make ice cream. The ice cream may be placed in a freezer for later consumption or may be immediately consumed. The amount of time necessary to make the ice cream in a dryer may vary based on several factors, including but not necessarily limited to size of the dryer, temperature in the dryer, ambient temperature in the room or environment in which the dryer is located, amount of ice cream mixture, amount of ice, amount of rock salt, shape of bladder/container for ice cream mixture, shape of bladder for ice cream mixture, shape of bladder for ice and rock salt.

### Bag

In one embodiment, it may be beneficial to enclose outer shell 520 (containing ice, salt, and an inner shell 530 with ice cream mixture) in container or bag 510. Bag 510 may be a container, packet, bag, or sleeve. In one embodiment bag 510 may be insulated. Enclosure in insulated bag 510 may result in one or more of at least four benefits: First, insulated bag 510 may keep the mixture of ice and rock salt colder. Although some melting is beneficial (a liquid is in contact with a greater area of the ice cream mixture bladder than ice alone), in many situations the ice may melt too quickly such that the ice is gone and the water begins to heat up. Second, and related to the first, is that less ice may be needed because the ice may melt more slowly. Third, using an insulated bag 510 keeps condensation moisture that forms on the outside of outer shell 520 from coming into contact with the dryer’s inside surface-which can make a mess. Fourth, the insulated bag 510 can be used to change the size and shape of the item inside the dryer (or other turbulence-inducing environment). This may be useful because particular size and shape features may allow the ice cream maker apparatus to turn and tumble in the dryer better. For example, in some dryers the fins may not extend all the way to the edge. If the ice cream maker apparatus is small enough to fit through the space between the end of the fin and the side of the dryer drum, then the ice cream maker apparatus may not be pulled to the top of the dryer, where it can fall to the bottom to generate turbulence. A larger insulated packet may mitigate and/or resolve this issue.

Bag 510 may be made and/or designed in many ways. Insulation (if it includes insulation) characteristics may also vary. The most important features for the insulated envelope include but are not necessarily limited to: (i) insulation and (ii) making it closeable or at least have a way to keep the ice bladder inside the insulated envelope. In one embodiment, the insulated envelope may have a three-layer construction similar to insulated food bags: inner waterproof layer, middle insulation layer, and exterior canvas/durable layer. These layers may be sewn together. The insulated envelope may be recloseable using a zipper or other closing mechanism.

As used herein, “ice cream mixture” may refer to any of recipes for making frozen or cooled confections, treats, or other food items. For example, instead of (or in addition to) a dairy-based recipe, ice cream mixture may comprise coconut milk, coconut cream, nut milk, oat milk, etc.

Similarly, as used herein, “ice cream” may refer to any of frozen or cooled confections, treats, or other food items. For example, instead of (or in addition to) a dairy-based recipe, ice cream may include coconut milk, coconut cream, nut milk, oat milk, etc.

What is claimed is:

1. A device for making ice cream, comprising:
a sealed inner shell containing ice cream mixture; and
a sealed outer shell containing the sealed inner shell, ice, and salt.

2. The device of claim 1, further comprising a bag containing the sealed outer shell.

3. The device of claim 2, wherein the bag is insulated.

4. The device of claim 2, wherein the bag is closeable by a closing mechanism.

5. The device of claim 4, wherein the closing mechanism is a zipper.

6. The device of claim 1, wherein the inner shell is made at least in part from silicone.

7. The device of claim 1, wherein the outer shell is made at least in part from silicone.

8. The device of claim 1, wherein:
the inner shell is made at least in part from silicone; and
the outer shell is made at least in part from silicone.

9. The device of claim 1, further comprising a tumbling machine containing the sealed outer shell.

10. The device of claim 9, wherein the tumbling machine is a dryer.

11. The device of claim 2, further comprising a tumbling machine containing the bag.

12. The device of claim 11, wherein the tumbling machine is a dryer.

13. The device of claim 3, further comprising:
a dryer containing the bag; and wherein:
the bag is closeable by a zipper;
the outer shell is made from silicone; and
the inner shell is made from silicone.

14. A method for making ice cream, comprising:
putting ice cream mixture into an inner shell;
sealing the inner shell;
putting the inner shell into an outer shell;
putting salt into the outer shell;
putting ice into the outer shell;
sealing the outer shell;
putting the outer shell into a tumbling machine; and
running the tumbling machine.

15. The method of claim 14, wherein the tumbling machine is a dryer.

16. The method of claim 14, further comprising putting the outer shell into a bag before putting the outer shell into the tumbling machine.

17. The method of claim 16, wherein the bag is an insulated bag.

18. The method of claim 14, wherein:
the inner shell is made at least in part from silicone; and
the outer shell is made at least in part from silicone.

19. The method of claim 17, wherein the insulated bag is closeable by a zipper.

20. The method of claim 17, wherein:
the outer shell is made from silicone; and
the inner shell is made from silicone.
